(19) United States
(12) Patent Application Publication
(10) Pub. No.: US 2008/0140986 A1
(43) Pub. Date: Jun. 12, 2008

(54) METHOD FOR ACCESSING TARGET REGISTER OF REGISTERS AND APPARATUS THEREOF

(76) Inventors: Chuan-Hua Chang, Taipei City (TW); Hong-Men Su, Hsinchu County (TW); Jen-Chih Tseng, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/608,247

(22) Filed: Dec. 8, 2006

(51) Int. Cl. G06F 12/06

(52) U.S. Cl. 711/202; 711/E12.078

(57) ABSTRACT

A method is disclosed for accessing a target register of a plurality of registers. The method includes: receiving an instruction containing a register index field; and mapping the register index field to the target register access index for accessing the target register. A data accessing apparatus corresponding to this method is also disclosed.

### BACKGROUND OF THE INVENTION

1. Field of the Invention

The present invention relates to a method for accessing a target register of a plurality of registers, and particularly relates to a method for accessing a target register of a plurality of registers via a specific register index field by mapping.

2. Description of the Prior Art

Conventionally, a processor-based computer performs an operation function via an instruction, where the size of the instruction is normally 32-bits, thus the 32-bit instruction is also named a word code. FIG. 1 is a schematic diagram illustrating a normal distribution of the fields of a prior art instruction 100. As shown in FIG. 1, the instruction 100 includes an op field, an rs field, an rt field, an rd field, a shamt field, and a funct field. As known by persons skilled in the art, the op field is an operation code, the rs field is used for indicating a first register of an operating source, the rt field is used for indicating a second register of the operating source, the rd field is used for indicating a register for storing the operation result, the shamt field is used for indicating a shift amount, and the funct is a function code. The size of the instruction is not limited to 32 bit, though, and can comprise other bit numbers such as 16-bit, and the partition of the instruction fields can also be different.

FIG. 2 is a schematic diagram illustrating a prior art register file 200 with a plurality of registers, which are used for storing data to be operated, such that the data does not need to be read from the memory and the operation speed is increased. As shown in FIG. 2, the register file 200 includes a plurality of registers 201, 203, 205, 207, 209 with individual register index from 0 to K-1. And the total number of registers in the register file is K. The rs, rt, and rd fields in the instruction shown in FIG. 1 are register indexes to access one of these registers in the register file per register index number. The rs and rt fields of the instruction instruct the data to be read from two registers and be operated on using an action defined by the op and funct fields of the instruction. When the operation is done, the rd field of the instruction then instructs the resulting data to be written into one particular register such that the resulting data can be used by subsequent instructions through another register file read operation. The detailed operations of the registers and the memory are well known by persons skilled in the art, and are thus omitted for brevity.

To be able to access all K registers in a register file by an instruction, a register index field needs to be encoded using (log₂K) number of bits. For example, for a register file of 32 registers, 5(log₂32==5) bits are needed for a register index field. Thus, to include three register index fields in an instruction (2 for source data, 1 for result data), 3*log₂K bits are required. For a register file of 32 registers, 15 bits then are needed.

For the benefits of performance improvement, most of modern 32-bit instruction processors have a register file of at least 32 registers. And for the benefits of memory cost reduction, most of modern 32-bit instruction processors have included 16-bit instruction format in their instruction set extensions to reduce the program size. However, the large number of registers and the reduced instruction size create a problem for each other.

Although the 32-bit instruction has enough space for three 5-bit register index fields (the rs field, the rt field, and the rd field shown in FIG. 1) that use a total of 15 bits, the 16-bit instruction cannot just use up all 15-bits for encoding register index fields and leave only one bit to encode two functions. To encode enough functions in a 16-bit instruction format for it to be useful, the number of register index fields encoded needs to be reduced (to 2 or 1) or the number of bits of a register index field needs to be reduced (to 4-bits or 3-bits). For the approach of using 3-bit and 4-bit register index fields, since the index is not large enough to access all 32 registers, only a subset of the 32 registers can be accessed. If the registers accessed by the 3-bit or 4-bit index field are not properly determined or controlled, the use of 16-bit instruction is severely limited, and the goal of using 16-bit instructions to reduce program memory size will not be met.

Thus, a new invention is needed to solve the above-mentioned problems.

### SUMMARY OF THE INVENTION

An objective of the present invention is to provide a method for accessing a target register of a plurality of registers, which can use a N-bit register index field to access 2^{M} registers in a register file indexed with M-bit register index, where N is less than M.

Another objective of the present invention is to provide an apparatus for accessing a target register of a plurality of registers, which can use an N-bit register index field to access 2^{M} registers in a register file indexed with M-bit register index, where N is less than M.

The present invention discloses a method for accessing a target register of a plurality of registers, comprising: receiving an instruction containing an N-bit register index field; and mapping the register index field to the full M-bit target register access index for accessing the target register. The step of mapping the N-bit register index field to the full M-bit target register access index may comprise: defining a minimum of 2^{(M-N)} or more programmable (controllable) mapping relations between possible values of the N-bit register index field and a subset of the registers in a register file such that all registers can be accessed via a combination of the minimum mapping relations; and accessing the target register of the specific registers according to the register index field and the selected mapping relation.

In particular, this invention discloses example mapping relations for N==3, N==4, and M==5. Also, the disclosed example mapping relations are optimally defined based on software usage convention to increase the occurrences of 16-bit instructions and minimize mapping relation changes.

The present invention also discloses a data accessing apparatus corresponding to the above-mentioned method. The apparatus comprises: a register file, comprising a plurality of registers; an instruction decoder, for receiving an instruction containing a N-bit register index field and extracting the register index field from the instruction; a mapping control unit for programming a particular mapping relation; and a mapping circuit, coupled to the instruction decoder, the mapping control unit, and the register file, for mapping the N-bit register index field to the full M-bit register access index for accessing the registers.

According to the above-mentioned method and apparatus, all registers accessed with an M-bit register access index in a register file can be accessed by instructions with a smaller N-bit register index field. Thus a smaller format instruction (such as 16-bit instruction) becomes much less restricted in its usage and will be used more often in a program to reduce the program size.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the fields of a prior art instruction.

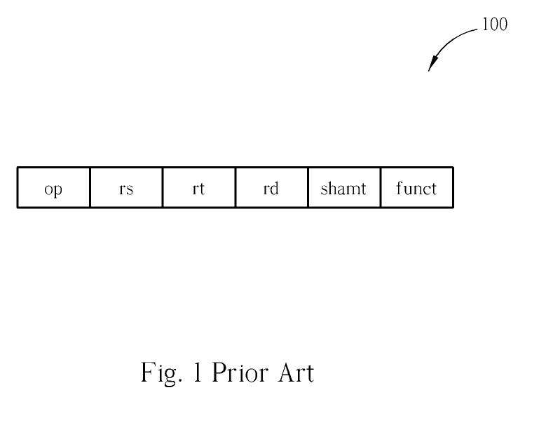

FIG. 2 is a schematic diagram illustrating a prior art register file with a plurality of registers.

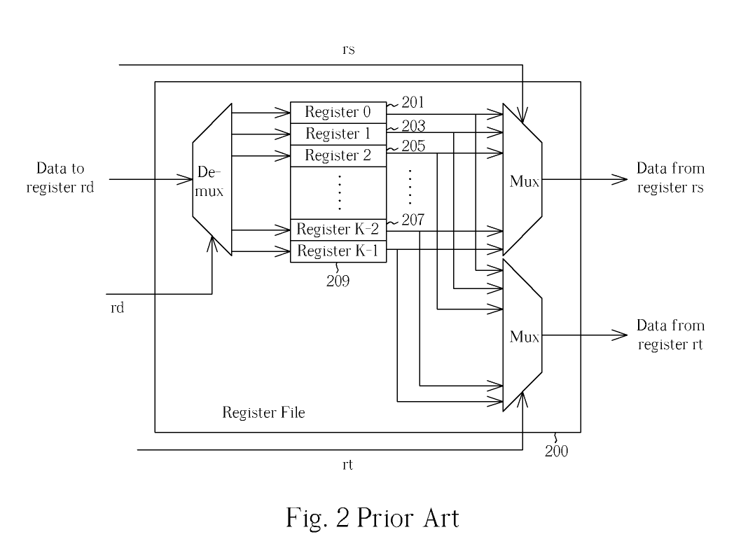

FIG. 3a is a flow diagram illustrating a method for accessing a target register according to a preferred embodiment of the present invention.

FIG. 3b is a flow diagram illustrating a slightly modified method for accessing a target register according to an alternative embodiment of the present invention.

FIG. 4 is a block diagram illustrating a data accessing apparatus for accessing a target register according to a preferred embodiment of the present invention.

FIG. 5a shows a detailed construction of a preferred embodiment of the mapping control unit for the 4-bit and 3-bit register index fields.

FIG. 5b is a block diagram illustrating an alternative embodiment of the mapping control unit in the disclosed data accessing apparatus.

FIG. 6 is a diagram illustrating the disclosed example mapping relations between a 5-bit indexed register file of 32 registers, a 4-bit register index field, and a 3-bit register index field.

FIG. 7 is a software code example illustrating the meaning and intended usage of a callee-saved register in software convention.

FIG. 8 is a software code example illustrating the meaning and intended usage of a caller-saved register in software convention.

### DETAILED DESCRIPTION

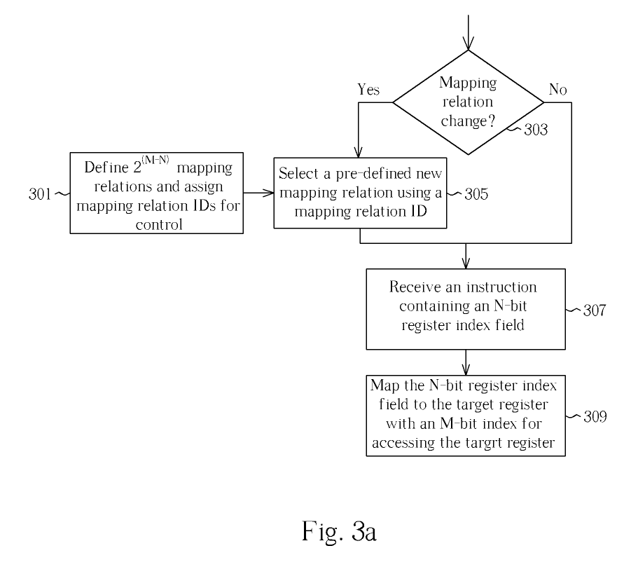

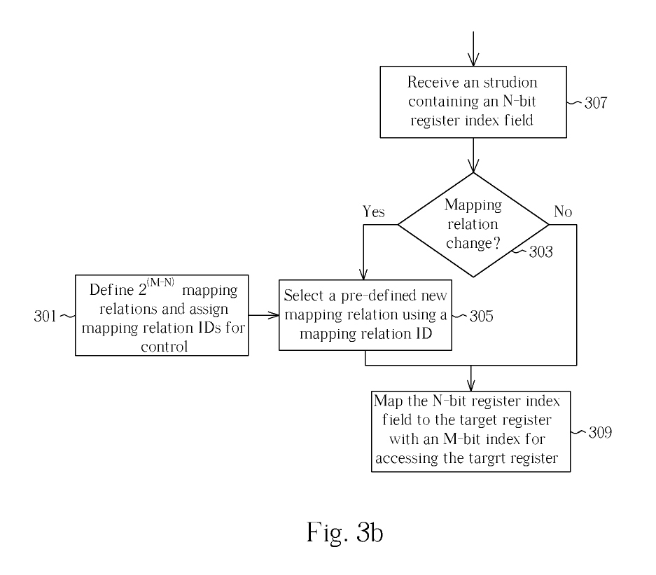

FIG. 3a is a flow diagram illustrating a method for accessing a target register according to a preferred embodiment of the present invention.

FIG. 3b is a flow diagram illustrating a slightly modified method for accessing a target register according to an alternative embodiment of the present invention.

As shown in FIG. 3a, the method comprises:

Step 301: Define 2^{(M-N)} mapping relations between a N-bit register index field and a M-bit access index indexed K(2^{N}<K≦2^{M}) registers such that each of the K registers has at least one relation defined. And assign each mapping relation an ID from 0 to 2^{(M-N)}−1 for controlling operation in step 305;

Step 303: Determine if the current mapping relation needs to be changed for the subsequent instruction processing. If the current mapping relation needs to be changed, go to step 305; if not, go to step 307.

Step 305: Select a pre-defined new mapping relation according to a new ID value during the control process, go to step 307.

Step 307: Receive an instruction containing an N-bit register index field and;

Step 309: Map the N-bit register index field to the target register with an M-bit index for accessing the target register.

In FIG. 3b, all the steps are exactly the same as those steps in FIG. 3a except that Step 307 is moved before Step 303.

In these two methods, all of the M-bit access index indexed K registers can be accessed by an N-bit register index field by controlling the appropriate mapping relation where N is less than M and 2^{N}<K<=2^{M}.

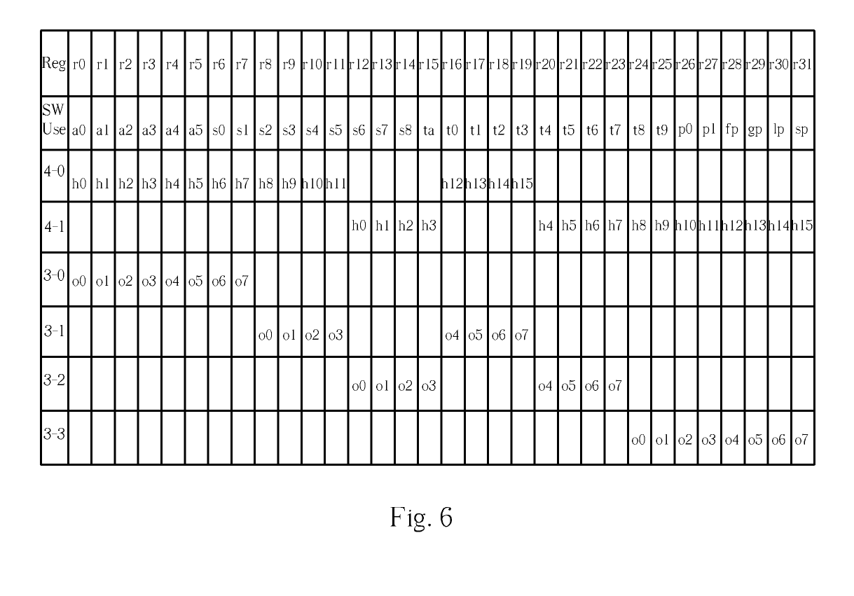

According to one example of the present invention, the register field is a 4-bit register index field and the number of the registers is 32 (indexed with 5-bits). In this case, the step 301 further comprises: define two (2⁽⁵⁻⁴⁾) mapping relations between the 4-bit register index field and specific registers based on software usage convention shown in FIG. 6; and assign each of them with ID 0 and 1.

According to another example of the present invention, the register field is a 3-bit register index field and the number of the registers is 32 (indexed with 5-bits). In this case, the step 301 further comprises: define four (2⁽⁵⁻³⁾) mapping relations between the 3-bit register index field and specific registers based on software usage convention shown in FIG. 6; and assign each of them with ID 0, 1, 2, and 3.

It should be noted that the scope of the present invention is not limited to the above-mentioned steps. For example, a specific mapping relation can be pre-defined, and the registers are accessed only according to this mapping relation. In this case, the defining step and selecting step shown in FIGS. 3a and 3b can be omitted.

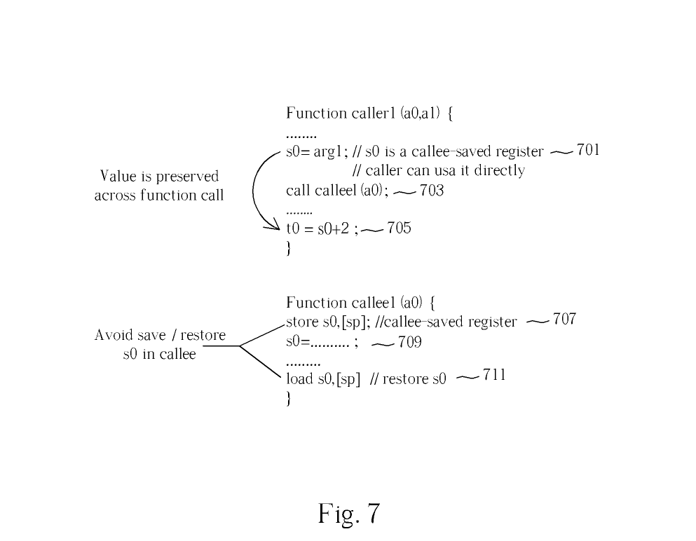

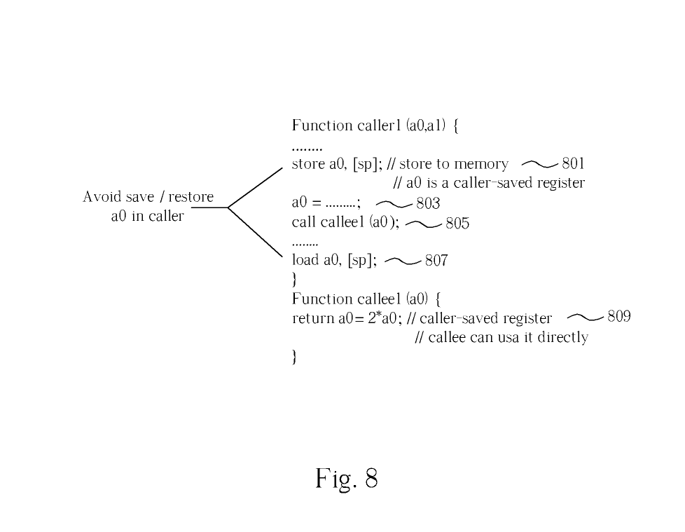

In FIG. 6, 4-0 means the mapping relation 0 of 4-bit register index field, 4-1 means the mapping relation 1 of 4-bit register index field, 3-0 means the mapping relation 0 of 3-bit register index field, 3-1 means the mapping relation 1 of 3-bit register index field, 3-2 means the mapping relation 2 of 3-bit register index field, and 3-3 means the mapping relation 3 of 3-bit register index field. As shown in FIG. 6, 32 registers r0-r31 are classified to various kinds of registers based on necessary software usages. As is well known in the art, these classified register groups in software usage include caller-saved, callee-saved, and special registers. For the preferred embodiment of this invention, registers a0-a5 are registers for storing function call parameters and passing return values, and they are most frequently used caller-saved temporary registers (illustrated in FIG. 8, statement 801, 805, and 807). Registers s0-s8 are callee-saved temporary registers and are preferred for storing values which need to be preserved across function calls (illustrated in FIG. 7, statement 707, and 709, and 711). Registers t0-t9 are caller-saved temporary registers and are preferred for storing values which do not need to be preserved across function calls (illustrated in FIG. 8, statement 801, 805, 807). Registers gp, sp, lp, fp, ta, p0, p1 are registers for specific purposes well known in the art. For example, the register fp is used for storing a frame pointer, and the register sp is used for storing a stack pointer.

In a general function that can be both a caller and a callee, both types of registers, caller-saved and callee-saved, are better to be included in a mapping relation to increase the usage of 16-bit instructions.

With this mapping rule, in the 4-bit register index field case, a preferred embodiment of the two mapping relations are defined as follows:

1. 4-bit index mapping relation ID 0 includes ten caller-saved registers, and six callee-saved registers;

2. 4-bit index mapping relation ID 1 includes three caller-saved registers, seven callee-saved registers, and six special registers.

In the 3-bit register index field case, a preferred embodiment of the four mapping relations are defined as follows:

1.3-bit index mapping relation ID 0 includes six caller-saved registers, and two callee-saved registers.

2.3-bit index mapping relation ID 1 includes four caller-saved registers, and four callee-saved registers.

3.3-bit index mapping relation ID 2 includes five caller-saved registers, and three callee-saved registers.

4.3-bit index mapping relation ID 3 includes two caller-saved registers, and six special registers.

It should be noted that the mapping relations shown in FIG. 6 is only one example and is not meant to limit the scope of the present invention.

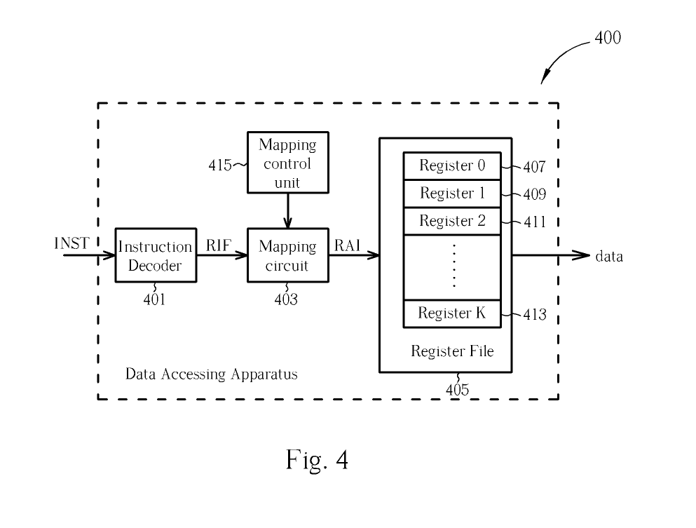

FIG. 4 is a block diagram illustrating a data accessing apparatus 400 for accessing a target register according to a preferred embodiment of the present invention. As shown in FIG. 4, the data accessing apparatus 400 includes an instruction decoder 401, a mapping circuit 403, a mapping control unit 415, and a register file 405 with a plurality of registers 407, 409, 411, and 413. It should be noted that the data accessing apparatus 400 is only a sketch map; detailed connections and structures are well known by persons skilled in the art and are therefore omitted for brevity. The instruction decoder 401 is used for receiving an instruction INST containing an N-bit register index field RIF and extracting the register index field RIF from the instruction INST. The mapping circuit 403 is used for mapping the N-bit register index field RIF to an M-bit register access index (RAI) for accessing one of the K registers 407, 409, 411, and 413. The mapping relation used in the mapping circuit 403 is setup and selected by a mapping control unit 415.

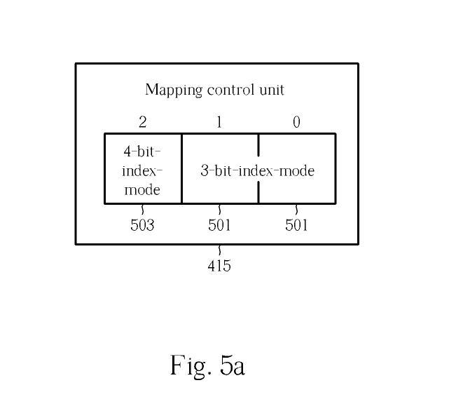

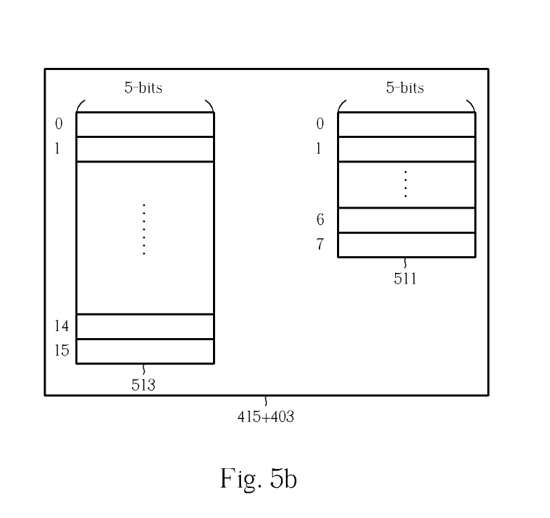

FIG. 5a shows a detailed construction of a preferred embodiment of the mapping control unit for the 4-bit and 3-bit register index fields. It comprises a one-bit field of 4-bit-index-mode (bit 2) and a two-bit field of 3-bit-index-mode (bit 1 and 0). The one bit field of 4-bit-index-mode is used to select one of the two defined mapping relations. The two-bit field of 3-bit-index-mode is used to select one of the four defined mapping relations.

FIG. 5b shows a detailed construction of an alternative embodiment of the mapping control unit 415 and the mapping circuit 413 for the 4-bit and 3-bit register index fields. It comprises,

(1) Sixteen 5-bit registers to store mapping relations between the 4-bit register index field and the 5-bit access index of the register file. And it can be programmed to select one of 32¹⁶ mapping relations, giving the most flexibility to control the mapping relations.

(2) Eight 5-bit registers to store mapping relations between the 3-bit register index field and the 5-bit access index of the register file. And it can be programmed to select one of 32⁸ mapping relations, giving the most flexibility to control the mapping relations.

According to the above-mentioned method and apparatus, all K registers indexed with an M-bit register access index in a register file can be accessed by instructions with a smaller N-bit register index field. Thus a smaller format instruction (such as 16-bit instruction) becomes much less restricted in its usage and will be used more in a program to reduce the program size. And the disclosed example mapping relations for the 4-bit and 3-bit register index fields based on software convention should further increase the usage of 16-bit instructions. Besides, as described above, a specific mapping relation can be pre-defined, and the registers are accessed only according to this mapping relation. In this case, since the mapping relation is fixed and does not need to be selected, the mapping control unit 415 shown in FIG. 4 can be omitted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for accessing a target register of a plurality of registers, comprising:
(a) receiving an instruction containing a register index field; and
(b) mapping the register index field to the target register for accessing the target register.

2. The method of claim 1, wherein each of the registers can be accessed by an M-bit access index, the register index field from the instruction is an N-bit register field, and N is less than M.

3. The method of claim 2, further comprising:
(a1) defining at least 2^{(M-N)} mapping relations between the N-bit register index field and the M-bit access index of the plurality of registers;
(a2) selecting a mapping relation among the defined mapping relations;
wherein the step (b) maps the register index field to the target register for accessing the target register, and each of the registers can be accessed using the register index field through the defined mapping relations.

4. The method of claim 1, wherein the register index field is a 4-bit register field, and the number of the registers is 32, requiring a 5-bit access index.

5. The method of claim 1, wherein the register index field is a 3-bit register field and the number of the registers is 32, requiring a 5-bit access index.

6. The method of claim 1, further comprising:
(a1) defining at least one mapping relation between a register index field and the access indexes of the plurality of registers;
(a2) selecting a mapping relation among the defined mapping relations;
wherein the step (b) maps the register index field to the target register for accessing the target register, and each of the registers can be accessed using the register index field through the defined mapping relations.

7. The method of claim 6, wherein the register index field is a 4-bit register field and the step (a1) comprises:
defining two mapping relations between the 4-bit register index field and the access index of specific registers, including:
(1) mapping a first relation including a group of caller-saved registers, and a group of callee-saved registers; and
(2) mapping a second relation including a group of caller-saved registers, a group of callee-saved registers, and a group of special registers.

8. The method of claim 6, wherein the register index field is a 3-bit register field and the step (a1) comprises:
defining four mapping relations between the 3-bit register index field and the access index of specific registers, including:
(1) mapping a first relation including a group of caller-saved registers, and a group of callee-saved registers;
(2) mapping a second relation including a group of caller-saved registers, and a group of callee-saved registers;
(3) mapping a third relation including a group of caller-saved registers, and a group of callee-saved registers;
(4) mapping a fourth relation including a group of caller-saved registers, and a group of special registers.

9. A data accessing apparatus, comprising:
a register file, comprising a plurality of registers;
an instruction decoder, for receiving an instruction containing a register index field and extracting the register index field from the instruction; and
a mapping circuit, coupled to the instruction decoder, and the register file, for mapping the register index field to the register access index for accessing the registers.

10. The data accessing apparatus of claim 9, wherein each of the registers can be accessed by an M-bit access index, the register index field of the instruction is an N-bit register field, and N is less than M.

11. The data accessing apparatus of claim 10, wherein at least 2^{(M-N)} mapping relations are pre-defined, and the data accessing apparatus further comprises a mapping control unit for selecting a mapping relation among the 2^{(M-N)} mapping relations.

12. The data accessing apparatus of claim 9, wherein a plurality of mapping relations are pre-defined, and the data accessing apparatus further comprises a mapping control unit for selecting a mapping relation among the defined mapping relations.

13. The data accessing apparatus of claim 12, wherein the register index field is a 4-bits register field, where the mapping circuit defines two mapping relations between the 4-bit register index field and the access index of specific registers via the steps including:
(1) mapping a first relation including a group of caller-saved registers, and a group of callee-saved registers; and
(2) mapping a second relation including a group of caller-saved registers, a group of callee-saved registers, and a group of special registers.

14. The data accessing apparatus of claim 12, wherein the register index field is a 3-bit register field, where the mapping circuit defines four mapping relations between the 3-bit register index field and the access index of specific registers via the steps including:
(1) mapping a first relation includes a group of caller-saved registers, and a group of callee-saved registers;
(2) mapping a second relation including a group of caller-saved registers, and a group of callee-saved registers;
(3) mapping a third relation including a group of caller-saved registers, and a group of callee-saved registers; and
(4) mapping a fourth relation including a group of caller-saved registers, and a group of special registers.

15. The data accessing apparatus of claim 9, wherein the register index field is a 4-bit register field and the number of the registers is 32, requiring a 5-bit access index.

16. The data accessing apparatus of claim 9, wherein the register index field is a 3-bit register field and the number of the registers is 32, requiring a 5-bit access index.
